(19) United States
(12) Patent Application Publication
(10) Pub. No.: US 2026/0278985 A1
(43) Pub. Date: Sep. 17, 2026

(54) INFORMATION PROCESSING APPARATUS

(71) Applicant: NEC Corporation, Tokyo (JP)

(72) Inventor: Junya INOH, Tokyo (JP)

(73) Assignee: NEC Corporation, Tokyo (JP)

(21) Appl. No.: 19/552,070

(22) Filed: Feb. 27, 2026

(30) Foreign Application Priority Data
Mar. 11, 2025 (JP) 2025-038420

(51) Int. Cl. G06V 10/25; G06N 20/00

(52) U.S. Cl. CPC G06V 10/25; G06N 20/00

(57) ABSTRACT

An information processing apparatus of the present disclosure includes a prediction unit that predicts a region in another prediction target captured image different from a predetermined prediction target captured image based on information output from a model by inputting information based on a plurality of the prediction target captured image obtained by capturing a prediction target and document information including findings for the predetermined prediction target captured image to the model. The model is machine-learned by using a pair of a first captured image obtained by capturing a predetermined target and first document information including a finding for the first captured image, and a pair of a second captured image obtained by capturing the predetermined target at different timings and first document information. The information processing apparatus of the present disclosure can support decision making of a doctor on medical diagnosis, for example.

### INCORPORATION OF BASIC APPLICATION

The present invention is based upon and claims the benefit of the priority of Japanese Patent Application No. 2025-038420 filed on March 11, 2025 in Japan, the disclosure of which is incorporated herein in its entirety by reference.

### TECHNICAL FIELD

The present disclosure relates to an information processing apparatus.

### BACKGROUND ART

With recent development of natural language processing and image processing technologies, it is possible to perform Phrase Grounding (Visual grounding, Image-Text alignment) of combining these and specifying a target based on an input of a natural language from an image. PTL 1 describes applying a Phrase Grounding technology to medical images. Specifically, PTL 1 describes that an image of a region of interest included in an inspection image is acquired from an interpretation report.

PTL 1: WO 2019/176407

### SUMMARY

However, in the technology described in PTL 1, in a case where the medical image is updated by newly capturing, the time series of the interpretation report and the medical image deviates, and there may be a case where the region of interest in the medical image cannot be appropriately specified. As a result, there arises a problem that it is difficult to specify a region in an image from document information such as an interpretation report.

Therefore, an object of the present disclosure is to solve the above-described problem that it is difficult to specify a region in an image from document information.

An information processing apparatus according to one aspect of the present disclosure includes
a prediction unit that predicts a region in another prediction target captured image different from a predetermined prediction target captured image based on information output from a model obtained by inputting information based on a plurality of prediction target captured images obtained by capturing a prediction target and document information including findings for the predetermined prediction target captured image to the model, wherein
the model is machine-learned using
first learning data including a combination of a pair of a first captured image obtained by capturing a predetermined target and first document information including a finding for the first captured image, and training data indicating a region in the first captured image, and
second learning data including a combination of a pair of a second captured image obtained by capturing the predetermined target at a timing different from a timing at which the first captured image is captured and the first document information, and training data indicating a region in the second captured image.

An information processing apparatus according to one aspect of the present disclosure includes
a learning unit that generates a model by machine learning
first learning data including a combination of a pair of a first captured image obtained by capturing a predetermined target and first document information including a finding for the first captured image, and training data indicating a region in the first captured image, and
second learning data including a combination of a pair of a second captured image obtained by capturing the predetermined target at a timing different from a timing at which the first captured image is captured and the first document information, and training data indicating a region in the second captured image.

An information processing method according to one aspect of the present disclosure includes,
with respect to a model machine-learned using
first learning data including a combination of a pair of a first captured image obtained by capturing a predetermined target and first document information including a finding for the first captured image, and training data indicating a region in the first captured image, and
second learning data including a combination of a pair of a second captured image obtained by capturing the predetermined target at a timing different from a timing at which the first captured image is captured and the first document information, and training data indicating a region in the second captured image,
by an information processing apparatus,
predicting a region in another prediction target captured image different from a predetermined prediction target captured image based on information output from the model by inputting information based on a plurality of the prediction target captured image obtained by capturing a prediction target and document information including findings for the predetermined prediction target captured image.

An information processing method according to one aspect of the present disclosure includes,
by an information processing apparatus,
generating a model by machine learning
first learning data including a combination of a pair of a first captured image obtained by capturing a predetermined target and first document information including a finding for the first captured image, and training data indicating a region in the first captured image, and
second learning data including a combination of a pair of a second captured image obtained by capturing the predetermined target at a timing different from a timing at which the first captured image is captured and the first document information, and training data indicating a region in the second captured image.

A program according to one aspect of the present disclosure causes,
with respect to a model machine-learned using
first learning data including a combination of a pair of a first captured image obtained by capturing a predetermined target and first document information including a finding for the first captured image, and training data indicating a region in the first captured image, and
second learning data including a combination of a pair of a second captured image obtained by capturing the predetermined target at a timing different from a timing at which the first captured image is captured and the first document information, and training data indicating a region in the second captured image,
an information processing apparatus to execute processing of
predicting a region in another prediction target captured image different from a predetermined prediction target captured image based on information output from the model by inputting information based on a plurality of the prediction target captured image obtained by capturing a prediction target and document information including findings for the predetermined prediction target captured image.

A program according to one aspect of the present disclosure causes
an information processing apparatus to execute processing of
generating a model by machine learning
first learning data including a combination of a pair of a first captured image obtained by capturing a predetermined target and first document information including a finding for the first captured image, and training data indicating a region in the first captured image, and
second learning data including a combination of a pair of a second captured image obtained by capturing the predetermined target at a timing different from a timing at which the first captured image is captured and the first document information, and training data indicating a region in the second captured image.

With the above configuration, the present disclosure can appropriately specify the region in the image from the document information.

### BRIEF DESCRIPTION OF THE DRAWINGS

FIG. 1 is a block diagram illustrating an example of a configuration of an information processing apparatus according to the present disclosure;

FIG. 2 is a flowchart illustrating an example of a processing operation by the information processing apparatus according to the present disclosure;

FIG. 3 is a flowchart illustrating an example of a processing operation by the information processing apparatus according to the present disclosure;

FIG. 4 is a diagram illustrating an example of processing by the information processing apparatus according to the present disclosure;

FIG. 5 is a diagram illustrating an example of processing by the information processing apparatus according to the present disclosure;

FIG. 6 is a diagram illustrating an example of processing by the information processing apparatus according to the present disclosure;

FIG. 7 is a block diagram illustrating an example of a hardware configuration of an information processing apparatus according to the present disclosure;

FIG. 8 is a block diagram illustrating an example of a configuration of an information processing apparatus according to the present disclosure; and

FIG. 9 is a flowchart illustrating an example of a processing operation by the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing apparatus 10 of the present disclosure is used to specify a region in an image from document information. Specifically, in the present example embodiment, the use of the information processing apparatus 10 to specify a region of interest such as a lesion in a medical image obtained by imaging a patient in another time series from a medical image obtained by imaging the patient in the medical field and an interpretation report of the medical image will be described as an example. However, the information processing apparatus 10 is not limited to specifying the region of interest from the medical image and the interpretation report in the medical field, and may specify the region in the image from any image and any document in any field.

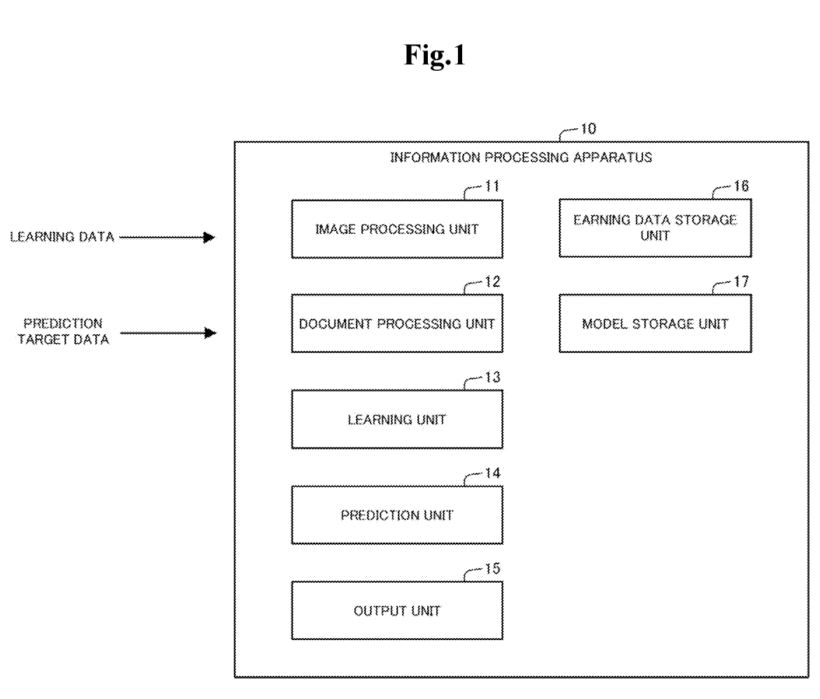

Hereinafter, an example of a configuration and an operation of the information processing apparatus 10 according to the present example embodiment will be described. The information processing apparatus 10 is configured with one or a plurality of information processing apparatuses including arithmetic apparatuses and storage apparatuses. Then, as illustrated in FIG. 1, the information processing apparatus 10 includes an image processing unit 11, a document processing unit 12, a learning unit 13, a prediction unit 14, and an output unit 15. Each function of the image processing unit 11, the document processing unit 12, the learning unit 13, the prediction unit 14, and the output unit 15 can be implemented by the arithmetic apparatus executing a program for implementing each function stored in the storage apparatus. The information processing apparatus 10 includes a learning data storage unit 16 and a model storage unit 17 implemented by a storage apparatus.

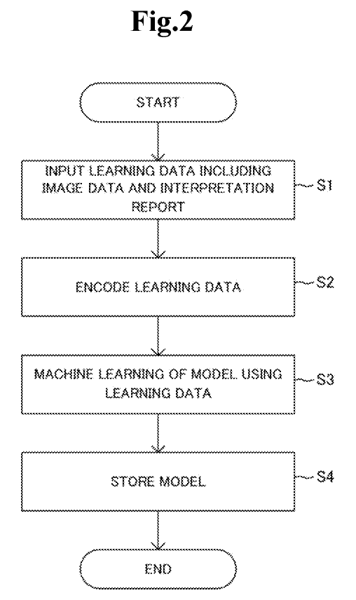

First, learning data is input to the information processing apparatus 10 (step S1 in FIG. 2), and the learning data is stored in the learning data storage unit 16. Then, the information processing apparatus 10 performs machine learning of the model using the learning data. In the present example embodiment, it is assumed that the information processing apparatus 10 performs machine learning of a Phrase Grounding model (hereinafter, referred to as a model) that specifies a target region from an image based on an input of natural language. In particular, in the present example embodiment, a model for specifying a region of interest from a medical image and an interpretation report is subjected to machine learning. Therefore, first, a configuration and an operation of generating a model by the information processing apparatus 10 will be described.

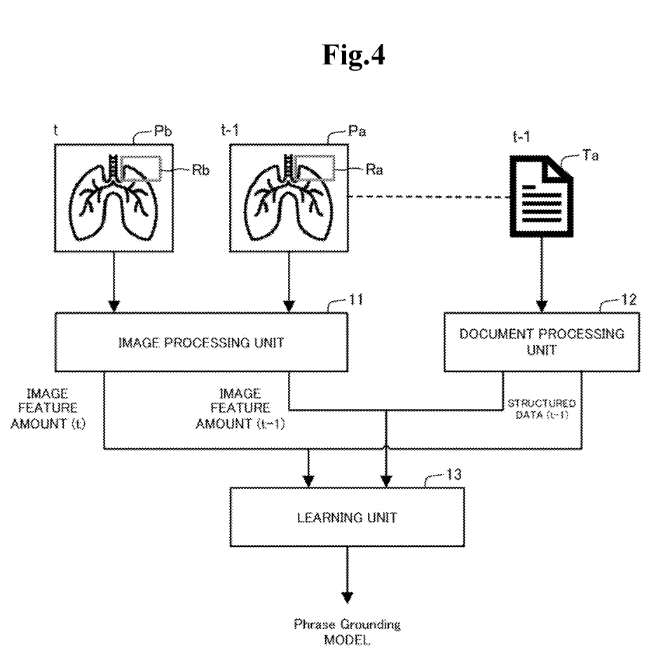

The learning data includes a first pair of image data (first captured image) that is a medical image obtained by capturing a patient (predetermined target) and an interpretation report (first document information) that is document information including findings by a doctor or the like on the image data. At this time, the image data is an image obtained by capturing a predetermined part of a patient in the medical field, for example, a two-dimensional image such as an X-ray photo, a three-dimensional image such as Computed Tomography (CT) or Magnetic Resonance Imaging (MRI), or a four-dimensional image. FIG. 4 illustrates, as an example, image data obtained by capturing a lung of a patient. The interpretation report is assumed to be text data including a finding sentence created by a doctor or the like for the image data. As an example, the interpretation report includes text data including contents of position information of the region of interest, a name of the region of interest, presence or absence of abnormality, and temporal change, such as “There is a small pneumothorax in the upper left lung apex. Infiltration in the right middle lung field is increasing. Infiltration is also seen in the lower left lobe”. The text data is not necessarily limited to the interpretation report, and may be data based on any information source such as a memo by a doctor or the like for the image data or data on an electronic medical record.

Here, it is assumed that the image data Pa and the interpretation report Ta constituting the first pair of learning data described above illustrated in FIG. 4 coincide in time series generated with each other. As an example, the image data Pa is captured at the past time t-1, and the interpretation report Ta is generated based on the image data Pa at the past time t-1. Then, a region of interest Ra in the image data Pa is further given to the first pair of learning data, and such a region of interest Ra becomes correct answer data (training data) of the first pair. As an example, in FIG. 4, the region of interest Ra is indicated by a gray rectangle, and is positioned related to the position information of the region of interest included in the interpretation report Ta. The region of interest Ra is not limited to a rectangular shape, and may have any shape. For example, the shape may be a figure such as a point, a pixel, a voxel, a grid having a certain size, or a shape of a box unit. It is assumed that information indicating that the image data Pa and the interpretation report Ta are the first pair, that is, information indicating that the time series of the image data Pa and the time series of the interpretation report Ta match is assigned to the first pair.

In addition to the first pair described above, the learning data also includes a second pair including a pair of image data Pb, which is a medical image obtained by capturing the same patient obtained by capturing the image data Pa included in the first pair, and the interpretation report Ta. At this time, the image data Pb constituting the second pair is obtained by capturing the same patient at a timing different from the timing at which the image data Pa constituting the first pair is captured. Specifically, the image data Pb constituting the second pair is captured at time t after time t-1 at which the image data Pa of the first pair is captured. On the other hand, the interpretation report Ta constituting the second pair is the same as the interpretation report of the first pair, and is the interpretation report including the finding sentence for the image data Pa of the first pair captured at the time t-1 before the time t at which the image data Pb of the second pair was captured. Then, a region of interest Rb in the image data Pb is further added to the second pair of learning data, and the region of interest Rb is the correct answer data (training data) of the second pair. As an example, in FIG. 4, the region of interest Rb is indicated by a gray rectangle. It is assumed that information indicating that the image data Pb and the interpretation report Ta are the second pair, that is, information indicating that the time series of the image data Pb and the time series of the interpretation report Ta do not match is assigned to the second pair.

As described above, the learning data includes, for the same patient, a first pair including a pair of the image data Pa and the interpretation report Ta at the time t-1 and a second pair including a pair of the image data Pb at the time t and the interpretation report Tb at the time t-1. The learning data includes data acquired from a large number of patients, and includes a large number of first and second pairs.

Here, in a case where the image data is captured at the above-described time t-1 and time t, for example, there is a case where follow-up observation is performed for the same patient. As another example, there is a case where the same patient is captured in a predetermined hospital and then captured in another introduced hospital.

Then, the image processing unit 11 includes an image encoder that performs analysis processing on the image data Pa and Pb included in the above-described learning data, and extracts an image feature amount that is a feature amount of the image data Pa and Pb (step S2 in FIG. 2). Examples of the image feature amount include a feature amount of a shape or a gray value of a predetermined region in the image data, but the image feature amount may be a value based on any feature on the image. The image processing unit 11 extracts the image feature amount (t-1) from the image data Pa of the first pair and extracts the image feature amount (t) from the image data Pb of the second pair.

The document processing unit 12 includes a text encoder that performs analysis processing on the interpretation report Ta included in the learning data described above, extracts a finding sentence in the interpretation report Ta, and further performs structuring (step S2 in FIG. 2). Specifically, the document processing unit 12 generates structured data by structuring the finding sentence of the interpretation report Ta into information such as position information of the region of interest, a name of the region of interest, presence or absence of abnormality, and a temporal change in state. For example, in the above-described example of the interpretation report Ta, structured data (t-1) such as “upper left lung apex” as the position information of the region of interest, “pneumothorax” as the name of the region of interest, “present” as the presence or absence of abnormality, and “increasing” as the temporal change in state is generated. However, the document processing unit 12 may structure the interpretation report Ta into any type of data, and may perform any analysis processing.

Then, the learning unit 13 performs machine learning for each of the first pair and the second pair of learning data described above to generate a model (step S3 in FIG. 2). Specifically, the learning unit 13 uses the image feature amount (t-1) of the image data at the time t-1 forming the first pair, the structured data (t-1) of the interpretation report Ta, and the information indicating that the time series match as inputs, and performs machine learning on the parameters of the model so as to output the region of interest Ra given as the correct answer data. The learning unit 13 uses the image feature amount (t) of the image data at the time t constituting the second pair, the structured data (t-1) of the interpretation report Ta, and the information indicating that the time series do not match as inputs, and performs machine learning on the parameters of the model so as to output the region of interest Rb given as the correct answer data.

The document processing unit 12 sequentially executes predetermined preprocessing in order to generate learning data in a format suitable for the machine learning processing by the learning unit 13, instead of simply performing the analysis processing as the natural sentence on the interpretation report Ta. Specifically, the document processing unit 12 performs, on the original text of the interpretation report Ta, normalization processing such as normalization of character codes, uniformity of full-width and half-width, uniformity of notation variations of numerical values and symbols, and uniformity of line feed codes, and then performs division processing into sentence units or phrase units and morphological analysis processing. In the morphological analysis processing, words indicating an anatomical part, a disease name, a state expression (“increase”, “reduction”, “deterioration”, “improvement”, and the like), and a negative expression (“none”, “not recognized”, and the like) are identified as a string of morphemes that can be extracted using a dictionary specialized for the medical field.

The document processing unit 12 applies predetermined rule-based processing or a machine learning-based unique expression extractor (for example, a unique expression recognition model using a recursive neural network or a Transformer type network) to the morphologically analyzed word string to extract an expression indicating position information of the region of interest (for example, “upper left lung apex”, “lower right lung field”, or the like), an expression indicating the name of the region of interest (for example, “pneumothorax”, “pneumonia”, “tumor”, or the like), an expression indicating the presence or absence of abnormality (for example, “present”, “not recognized”, or the like), and an expression indicating a temporal change of the state (for example, “increasing”, “improving” or the like) in association with each other. Each extracted expression is classified into any one of a position category, a disease name category, an abnormality presence/absence category, and a temporal change category of the region of interest based on a predefined category system.

The document processing unit 12 assigns a unique index to each expression in a category based on a vocabulary table defined for each category in order to convert the expressions classified into each category into a numerical vector easy to handle by the learning unit 13. Next, the position information of the region of interest, the name of the region of interest, the presence or absence of abnormality, and the temporal change of the state are expressed as embedding vectors of a predetermined number of dimensions by referring to an embedding matrix learned in advance or simultaneously learned by the learning unit 13 using the index as an input. In a case where any information is not explicitly indicated in the finding sentence, the document processing unit 12 assigns a dedicated index indicating the missing information and uses the embedding vector related to the index to explicitly handle the missing in the learning data.

Furthermore, the document processing unit 12 vector-concatenates an embedding vector of the position information of the region of interest, an embedding vector of the name of the region of interest, an embedding vector indicating the presence or absence of abnormality, and an embedding vector indicating a temporal change of the state, thereby generating a structured vector s (t-1) expressing the entire finding sentence. If necessary, metadata such as examination date and time, patient attributes (age, sex, or the like), and imaging conditions may be similarly quantified and added to s (t-1). The structured data (t-1) generated in this manner is stored in a predetermined memory and input to the learning unit 13.

The document processing unit 12 may use a text encoder for considering context information of the entire interpretation report Ta in addition to the generation of the embedding vector for each category as described above. For example, the document processing unit 12 can divide the finding sentence of the interpretation report Ta into token strings, apply a recursive neural network or a Transformer type self-attention network as a text encoder, calculate a sentence vector representing the meaning of the entire finding sentence, connect or add the sentence vector with the structured vector s (t-1), and input a text feature vector having a larger information amount to the learning unit 13.

The learning unit 13 integrates the image feature amount of the image data extracted in advance by the image processing unit (not illustrated) and the structured data generated by the document processing unit 12, and updates the model parameters so as to output the regions of interest Ra and Rb given as the correct answer data. Specifically, the learning unit 13 vector-concatenates the image feature amount vector f (t-1) obtained from the image data at time t-1, the structured vector s (t-1), and the flag value (for example, a 1-bit or 1-element numerical value with a match of 1 and a mismatch of 0) indicating that the time series match, and generates the integrated feature vector x1 related to the first pair. Similarly, the image feature amount vector f (t) obtained from the image data at the time t, the structured vector s (t-1), and the flag value indicating that the time series do not match are concatenated to generate the integrated feature vector x2 related to the second pair.

The learning unit 13 uses the integrated feature vectors x1 and x2 as inputs, and configures a model using a neural network including a plurality of stages of fully connected layers, a non-linear activation function (for example, ReLU function), and a dropout layer. The output layer of the model is configured to output a probability or a score that is a region of interest among the plurality of candidate regions in the image, and calculates a probability distribution that each candidate region is a correct region of interest using, for example, a softmax function. The regions of interest Ra and Rb as the correct answer data are given as labels related to the correct answer regions from among the candidate regions, and a cross entropy loss or the like is used as a loss function with respect to the model output.

In order to update the model parameter so that the value of the loss function becomes small, the learning unit 13 applies the gradient descent method based on the back propagation method or its derivative algorithm (for example, stochastic gradient descent (SGD), Adam, RMSprop, or the like). Specifically, the learning unit 13 reads the mini-batch including the plurality of first pairs and second pairs from the storage apparatus, calculates the value of the loss function by executing the forward operation of the model for each pair, and obtains the sum or the average thereof as the mini-batch loss. Subsequently, the gradient of each parameter with respect to the mini-batch loss is obtained by back propagation, and the model parameter is updated based on the gradient. By repeating this processing at a plurality of epochs for all the learning data, it is possible to obtain a model that outputs a correct region of interest with a high probability while discriminating a pair whose time series matches and a pair whose time series does not match.

The learning unit 13 may perform data expansion and sampling control on the learning data in order to improve learning stability and generalization performance. For example, image conversion such as rotation, translation, scaling, and noise addition is performed on the image data, and replacement of words based on the synonym dictionary, addition of notation variations, and the like are performed on the interpretation report Ta, whereby variations due to differences between the medical image apparatus and the presenter can be reproduced on the learning data. Furthermore, by adjusting the number of samplings of the first pair with the same time series and the second pair not with the same time series so that the ratio of the first pair with the same time series and the second pair not with the same time series does not become extreme, it is possible to perform learning without excessively deviating the information of the time series matching flag.

As described above, the document processing unit 12 and the learning unit 13 of the present example embodiment integrate the medical image data and the interpretation report Ta as a numerical vector, and repeatedly execute specific numerical operation processing (forward operation and back propagation processing of a neural network) by a computer, thereby generating a model for automatically estimating the regions of interest Ra and Rb. As a result, it is possible to automatically extract the candidate of the region of interest with respect to the medical image and support the confirmation work by the radiologist, and it is possible to obtain a specific technical effect that the presentation processing of the region of interest with respect to the medical image is performed at high speed and with high accuracy as the entire medical image diagnostic apparatus.

As described above, the learning unit 13 performs machine learning on the model by using both the learning data of the first pair in which the time series of the image data and the interpretation report is matched and the learning data of the second pair in which the time series of the image data and the interpretation report is not matched, so that the model is machine-learned to output the region of interest according to the image data and the interpretation report in consideration of whether the time series is matched. For example, information that does not change over time, such as position information of the region of interest, may be learned with a high degree of importance. As described above, by structuring the text data of the interpretation report, it is possible to reduce variations due to the writer, and to explicitly learn a lack of information and what information each word/phrase has, excluding unnecessary information. Then, the learning unit 13 stores the machine-learned model in the model storage unit 17.

In the learning unit 13, information indicating whether the time series assigned to the first pair and the second pair match or do not match need not necessarily be used for machine learning. For example, the first pair and the second pair may not include information indicating that the time series match/do not match. Even in this case, the learning unit 13 performs machine learning on both the first pair in which the time series of the image data and the interpretation report match and the second pair in which the time series of the image data and the interpretation report does not match, and performs machine learning including the information indicating the temporal change in the interpretation report. Therefore, the parameters of the model are machine-learned so as to output the region of interest in consideration of the temporal change.

The above-described machine learning method by the learning unit 13 is an example, and the model may be generated by another machine learning method. For example, the learning unit 13 may perform machine learning of a model in a 0 shot format in which a similarity between input text data and image data is calculated using a preliminary learning model by contrastive learning, and an intermediate output such as attention at that time is displayed as a heat map on the image data.

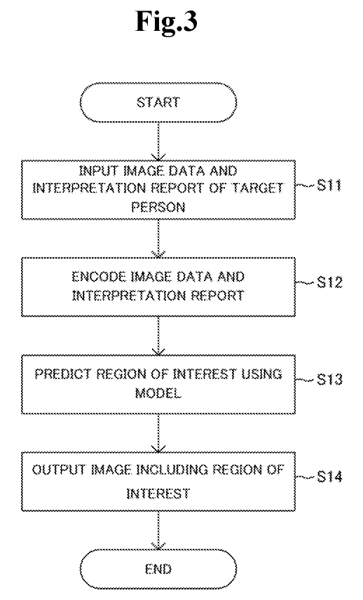

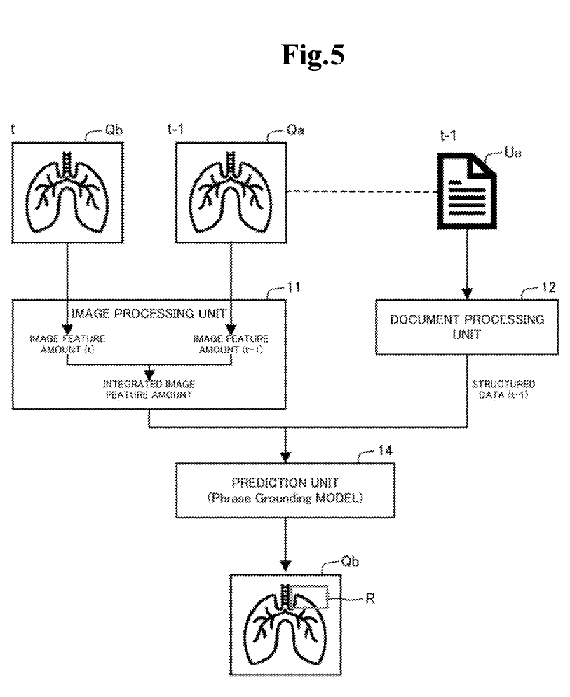

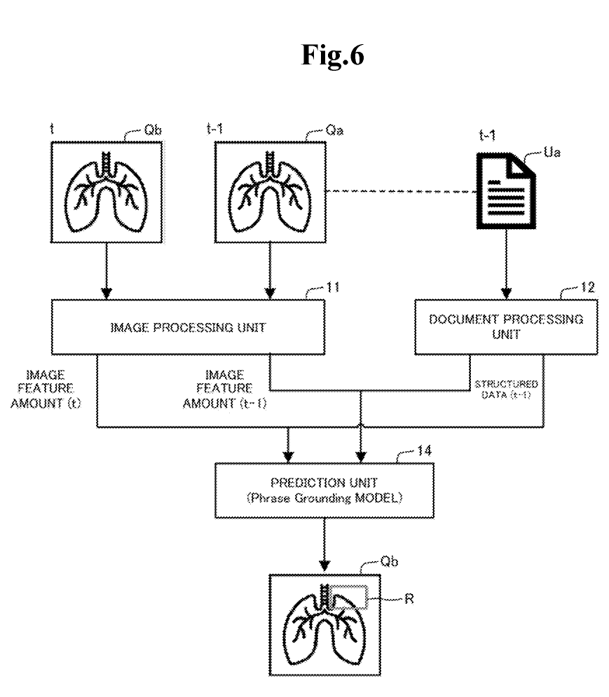

Next, a configuration and an operation when prediction is performed using a model by the information processing apparatus 10 will be described. First, prediction target data that is data of a patient to be predicted is input to the information processing apparatus 10 (step S11 in FIG. 3). At this time, the input prediction target data includes a plurality of pieces of image data (prediction target captured image) that are medical images obtained by imaging the patient (prediction target), and an interpretation report (document information) that is document information including findings by a doctor or the like on predetermined image data among the plurality of pieces of image data. More specifically, as illustrated in FIGS. 5 and 6, the input prediction target data includes a combination of the image data Qa captured at the past time t-1, the image data Qb captured at the subsequent time t, and the interpretation report Ua generated based on the image data Qa at the past time t-1 in the same patient. That is, the prediction target data includes two pieces of image data Qa and Qb captured at different timings in the same patient and the interpretation report Ua related to the previously captured image data Qa.

The prediction target data as described above can be input, for example, in a case where follow-up observation is performed for the same patient. Specifically, for the same patient, there is a case where the image data Qa and the interpretation report Ua are acquired in the image examination at the past time t-1, and the image data Qb is acquired in the image examination at the time t that is the follow-up time thereafter. For the same patient, there is a case where the image data Qa and the interpretation report Ua are acquired in the image examination in the first hospital at the past time t-1, and the image data Qb is acquired in the image examination in the second hospital introduced thereafter. The image data Qa and Qb may be any image such as an X-ray photo, CT, or MRI as described above, and the interpretation report Ua may be any text data such as a memo by a doctor or the like or data on an electronic medical record as described above.

Subsequently, in the present example embodiment, the information processing apparatus 10 performs prediction for the prediction target data, that is, prediction of the region of interest R in the image data Qb at the time t, by the following two methods.

First, a first method of prediction will be described. Similarly to the above, the image processing unit 11 extracts image feature amounts that are feature amounts of the image data Qa and Qb by a common image encoder that performs analysis processing on the image data Qa and Qb constituting the prediction target data (step S12 in FIG. 3). Examples of the image feature amount include a feature amount of a shape or a gray value of a predetermined region in the image data as described above, but the image feature amount may be a value based on any feature on the image. As illustrated in FIG. 5, the image processing unit 11 extracts the image feature amount (t-1) from the image data Qa and extracts the image feature amount (t) from the image data Qb by the image encoder.

Further, the image processing unit 11 integrates the image feature amount (t-1) extracted from the image data Qa and the image feature amount (t) extracted from the image data Qb to generate an integrated image feature amount. At this time, the image processing unit 11 generates the integrated image feature amount so as to represent the image feature amount of one piece of image data from the image feature amount (t-1) and the image feature amount (t). As a method of integrating the image feature amounts, an integrated model machine-learned in advance may be used, or may be performed by a method of adding a new dimension of time.

Similarly to the above, the document processing unit 12 extracts the finding sentence in the interpretation report Ta by the text encoder that performs the analysis processing on the interpretation report Ua constituting the prediction target data, and further performs structuring (step S12 in FIG. 3). Specifically, the document processing unit 12 generates structured data (t-1) obtained by structuring the finding sentence of the interpretation report Ta into information such as position information of the region of interest, a name of the region of interest, presence or absence of abnormality, and a temporal change in the state of the region of interest.

Then, as illustrated in FIG. 5, the prediction unit 14 inputs the integrated image feature amount and the structured data (t-1) based on the image data Qa and Qb and the interpretation report Ua, which are the prediction target data, to the model. In response to this, the region of interest R according to the input image data and interpretation report is output from the model (step S13 in FIG. 3). As a result, the prediction unit 14 sets the region of interest R output from the model as the predicted region of interest R in the image data Qb. Although the rectangular region of interest R is illustrated in the example of FIG. 6, the prediction unit 14 may predict the region of interest R in units of points or other shapes, for example, pixels or voxels, grids or boxes having a certain size, or may predict the similarity between the regions according to the output from the model.

Thereafter, the output unit 15 outputs information of the predicted region of interest R (step S14 in FIG. 3). For example, the output unit 15 superimposes and outputs the region R of interest on the image data Qb on a display apparatus that can be viewed by a medical worker such as a doctor or a patient. As a result, it is possible to support the decision making of the medical diagnosis by the doctor.

Next, a second method of prediction will be described. Similarly to the above, the image processing unit 11 extracts image feature amounts that are feature amounts of the image data Qa and Qb by a common image encoder that performs analysis processing on the image data Qa and Qb constituting the prediction target data (step S12 in FIG. 3). Examples of the image feature amount include a feature amount of a shape or a gray value of a predetermined region in the image data as described above, but the image feature amount may be a value based on any feature on the image. As illustrated in FIG. 6, the image processing unit 11 extracts the image feature amount (t-1) from the image data Qa and extracts the image feature amount (t) from the image data Qb by the image encoder.

Similarly to the above, the document processing unit 12 extracts the finding sentence in the interpretation report Ta by the text encoder that performs the analysis processing on the interpretation report Ua constituting the prediction target data, and further performs structuring (step S12 in FIG. 3). Specifically, the document processing unit 12 generates structured data (t-1) obtained by structuring the finding sentence of the interpretation report Ta into information such as position information of the region of interest, a name of the region of interest, presence or absence of abnormality, and a temporal change in the state of the region of interest.

Then, as illustrated in FIG. 6, the prediction unit 14 inputs a pair of the image feature amount (t-1) of the image data Qa as the prediction target data and the structured data (t-1) of the interpretation report Ua and a pair of the image feature amount (t) of the image data Qb as the prediction target data and the structured data (t-1) of the interpretation report Ua to the model. Then, the region of interest according to each of the two input pairs is output from the model. That is, the region of interest in the image data Qa and the region of interest in the image data Qb are predicted. Therefore, the prediction unit 14 generates the region of interest R in the image data Qb based on the region of interest in each of the image data Qa and the image data Qb (step S13 in FIG. 3). For example, the prediction unit 14 performs some kind of integration processing such as an overlapping region or a summed region in the region of interest in each of the image data Qa and the image data Qb, and predicts the region of interest R in the image data Qb.

Thereafter, the output unit 15 outputs information of the predicted region of interest R (step S14 in FIG. 3). For example, the output unit 15 superimposes and outputs the region R of interest on the image data Qb on a display apparatus that can be viewed by a medical worker such as a doctor or a patient. As a result, it is possible to support the decision making of the medical diagnosis by the doctor.

As described above, in the present disclosure, the model is generated by performing machine learning on both the pair of the image data and the interpretation report having the same time series and the pair of the image data and the interpretation report whose time series do not match. Therefore, even in a case where the image data to be predicted and the interpretation report do not match in time series, it is possible to appropriately specify the region of interest in the image data based on the interpretation report. In the present disclosure, by structuring the text data of the interpretation report, it is possible to appropriately learn an expression including a temporal change in the text data. As a result, even in a case where the image data to be predicted and the interpretation report do not match in time series, it is possible to more appropriately specify the region of interest in the image data based on the interpretation report.

### Second Example Embodiment

Next, a second example embodiment of the present disclosure will be described with reference to the drawings. In the present example embodiment, an outline of the information processing apparatuses and the like described in the above-described example embodiments will be illustrated. The drawings may relate to any example embodiment.

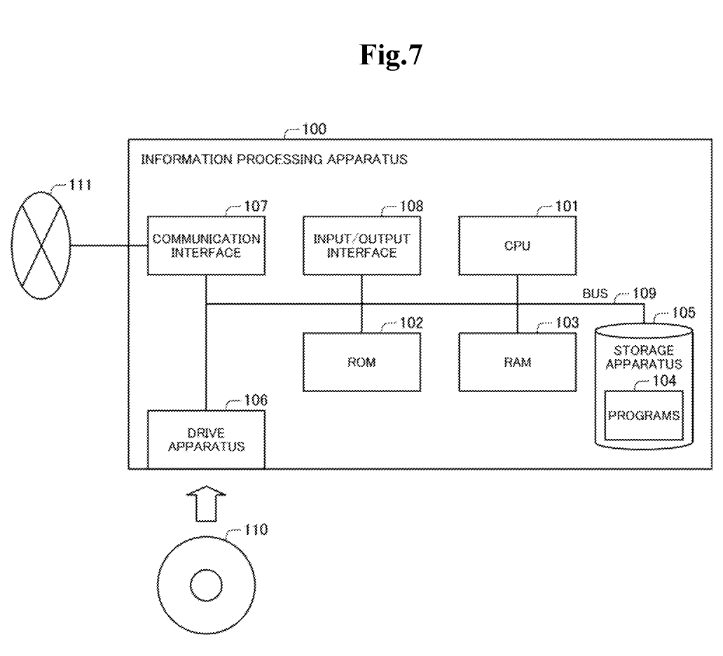

First, a hardware configuration of an information processing apparatus 100 in the present disclosure will be described. The information processing apparatus 100 is configured as a general information processing apparatus and has the following hardware configuration, as illustrated in FIG. 7, as an example.
A central processing unit (CPU) 101 (arithmetic apparatus)
A read only memory (ROM) 102 (storage apparatus)
A random access memory (RAM) 103 (storage apparatus)
Programs 104 to be loaded into the RAM 103
A storage apparatus 105 that stores the programs 104
A drive apparatus 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 7 illustrates an example of the hardware configuration of the information processing apparatus that is the information processing apparatus 100, and the hardware configuration of the information processing apparatus is not limited to the above case. For example, the information processing apparatus may be constituted by a part of the above-described configuration such as not including the drive apparatus 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

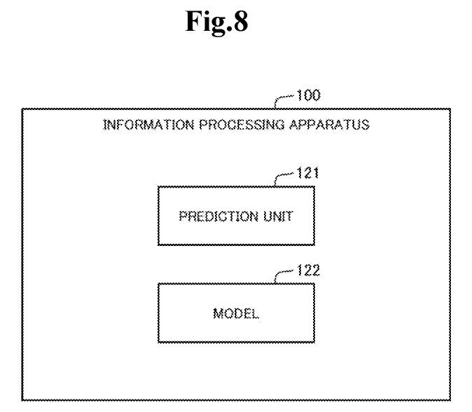

Then, the information processing apparatus 100 can construct and equip the prediction unit 121 illustrated in FIG. 8 by the CPU 101 acquiring the programs 104 and the CPU 101 executing the programs. The programs 104 are stored in, for example, the storage apparatus 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive apparatus 106 may read the programs 104 and supply the read programs 104 to the CPU 101. However, the prediction unit 121 described above may be constructed with a dedicated electronic circuit for implementing such a means.

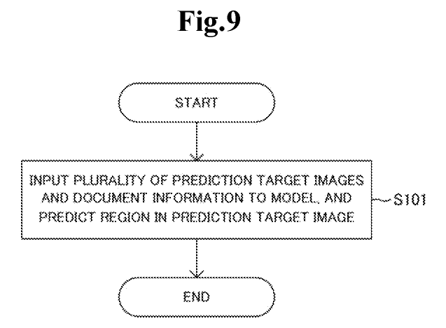

The prediction unit 121 predicts a region in another prediction target captured image different from the predetermined prediction target captured image based on the information output from the model by inputting the information based on the plurality of prediction target captured images obtained by capturing the prediction target and the document information including the finding for the predetermined prediction target captured image to the model (step S101 in FIG. 9). At this time, the model is machine-learned by using first learning data including a combination of a pair of a first captured image obtained by capturing a predetermined target and first document information including findings for the first captured image, and training data indicating a region in the first captured image, and second learning data including a combination of a pair of a second captured image obtained by capturing a predetermined target at a timing different from a timing at which the first captured image is captured, and first document information, and training data indicating a region in the second captured image.

In the above configuration, the information processing apparatus 100 predicts the region in the specific prediction target captured image from the prediction target captured image and the document information using the model machine-learned using both the pair in which the time series of the first captured image and the first document information match each other and the pair in which the time series of the second captured image and the first document information do not match each other. Therefore, even in a case where the time series of the prediction target captured image and the document information do not match, it is possible to appropriately specify the region in the prediction target captured image based on the document information.

At least one or more of the functions of the prediction unit 121 described above may be executed by an information processing apparatus installed and connected at any place on the network, that is, may be executed by so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, a flexible disk, a magnetic tape, or a hard disk drive), a magneto-optical recording medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

### Supplementary Note

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following Supplementary Notes.

Some or all of the configurations described in Supplementary Notes 2 to 7 dependent on Supplementary Note 1 described below and the functions according to those configurations can also be dependent on other Supplementary Notes 8 to 12 by a dependency relationship similar to that of Supplementary Notes 2 to 7. Moreover, one, some, or all of the configurations described as Supplementary Notes and the functions according to those configurations can be similarly dependent from not only Supplementary Notes 1 and 8 to 12, but also various pieces of similar hardware and software, and various types of recording means for recording the software, or systems without departing from the above-described example embodiments.

### Supplementary Note 1

An information processing apparatus including
a prediction unit that predicts a region in another prediction target captured image different from a predetermined prediction target captured image based on information output from a model obtained by inputting information based on a plurality of prediction target captured images obtained by capturing a prediction target and document information including findings for the predetermined prediction target captured image to the model, wherein
the model is machine-learned using:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image.

### Supplementary Note 2

The information processing apparatus according to Supplementary Note 1, wherein
the prediction unit predicts a region in the another prediction target captured image based on information output from the model by inputting, to the model, information based on a plurality of the prediction target captured image obtained by capturing the prediction target at different timings and the document information for the predetermined prediction target captured image.

### Supplementary Note 3

The information processing apparatus according to Supplementary Note 2, wherein
the prediction unit predicts a region in the another prediction target captured image based on information output from the model by inputting information based on a first prediction target captured image obtained by capturing the prediction target at a first timing and a second prediction target captured image obtained by capturing the prediction target at a timing different from the first timing, and the document information for the first prediction target captured image to the model.

### Supplementary Note 4

The information processing apparatus according to Supplementary Note 3, wherein
the prediction unit predicts a region in the another prediction target captured image based on information output from the model by inputting an integrated image obtained by integrating the first prediction target captured image and the second prediction target captured image and the document information to the model.

### Supplementary Note 5

The information processing apparatus according to Supplementary Note 3, wherein
the prediction unit predicts a region in the another prediction target captured image based on information output from the model by inputting each of a pair of the first prediction target captured image and the document information and a pair of the second prediction target captured image and the document information to the model.

### Supplementary Note 6

The information processing apparatus according to Supplementary Note 1, wherein
the model is machine-learned using the first learning data including information indicating that the first captured image and the first document information match in time series, and the second learning data including information indicating that the second captured image and the first document information do not match in time series.

### Supplementary Note 7

The information processing apparatus according to Supplementary Note 1, wherein
the model is machine-learned in a state in which the first document information is structured by at least position information of a region in the first captured image and information indicating a temporal change in a state of the region, and
the prediction unit predicts a region in the another prediction target captured image based on information output from the model by inputting the first document information to the model in a structured state of at least position information of a region in the first captured image and information indicating a temporal change in a state of the region.

### Supplementary Note 8

An information processing apparatus including
a learning unit that generates a model by machine learning:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image.

### Supplementary Note 9

An information processing method including,
with respect to a model machine-learned using:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image,
by an information processing apparatus,
predicting a region in another prediction target captured image different from a predetermined prediction target captured image based on information output from the model by inputting information based on a plurality of the prediction target captured image obtained by capturing a prediction target and document information including findings for the predetermined prediction target captured image.

### Supplementary Note 10

An information processing method including,
by an information processing apparatus,
generating a model by machine learning:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image.

### Supplementary Note 11

A program for causing,
with respect to a model machine-learned using:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image,
an information processing apparatus to execute processing of
predicting a region in another prediction target captured image different from a predetermined prediction target captured image based on information output from the model by inputting information based on a plurality of the prediction target captured image obtained by capturing a prediction target and document information including findings for the predetermined prediction target captured image.

### Supplementary Note 12

A program for causing
an information processing apparatus to execute processing of
generating a model by machine learning:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image.

### REFERENCE SIGNS LIST

10 information processing apparatus

11 image processing unit

12 document processing unit

13 learning unit

14 prediction unit

15 output unit

16 learning data storage unit

17 model storage unit

100 information processing apparatus

101 CPU

102 ROM

103 RAM

104 programs

105 storage apparatus

106 drive apparatus

107 communication interface

108 input/output interface

109 bus

110 storage medium

111 communication network

121 prediction unit

122 model

1. An information processing apparatus comprising:
at least one memory configured to store processing instructions; and
at least one processor configured to execute the processing instructions to
predict a region in another prediction target captured image different from a predetermined prediction target captured image based on information output from a model obtained by inputting information based on a plurality of prediction target captured images obtained by capturing a prediction target and document information including findings for the predetermined prediction target captured image to the model, wherein
the model is machine-learned using:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image.

2. The information processing apparatus according to claim 1, wherein the at least one processor is configured to execute the processing instructions to
predict a region in the another prediction target captured image based on information output from the model by inputting, to the model, information based on a plurality of the prediction target captured image obtained by capturing the prediction target at different timings and the document information for the predetermined prediction target captured image.

3. The information processing apparatus according to claim 2, wherein the at least one processor is configured to execute the processing instructions to
predict a region in the another prediction target captured image based on information output from the model by inputting information based on a first prediction target captured image obtained by capturing the prediction target at a first timing and a second prediction target captured image obtained by capturing the prediction target at a timing different from the first timing, and the document information for the first prediction target captured image to the model.

4. The information processing apparatus according to claim 3, wherein the at least one processor is configured to execute the processing instructions to
predict a region in the another prediction target captured image based on information output from the model by inputting an integrated image obtained by integrating the first prediction target captured image and the second prediction target captured image and the document information to the model.

5. The information processing apparatus according to claim 3, wherein the at least one processor is configured to execute the processing instructions to
predict a region in the another prediction target captured image based on information output from the model by inputting each of a pair of the first prediction target captured image and the document information and a pair of the second prediction target captured image and the document information to the model.

6. The information processing apparatus according to claim 1, wherein
the model is machine-learned using the first learning data including information indicating that the first captured image and the first document information match in time series, and the second learning data including information indicating that the second captured image and the first document information do not match in time series.

7. The information processing apparatus according to claim 1, wherein
the model is machine-learned in a state in which the first document information is structured by at least position information of a region in the first captured image and information indicating a temporal change in a state of the region, and
the at least one processor is configured to execute the processing instructions to
predict a region in the another prediction target captured image based on information output from the model by inputting the first document information to the model in a structured state of at least position information of a region in the first captured image and information indicating a temporal change in a state of the region.

8. An information processing apparatus comprising:
at least one memory configured to store processing instructions; and
at least one processor configured to execute the processing instructions to
generate a model by machine learning:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image.

9. An information processing method comprising,
with respect to a model machine-learned using:
first learning data including a combination of a pair of a first captured image obtained by capturing a predetermined target and first document information including a finding for the first captured image, and training data indicating a region in the first captured image; and
second learning data including a combination of a pair of a second captured image obtained by capturing the predetermined target at a timing different from a timing at which the first captured image is captured and the first document information, and training data indicating a region in the second captured image,
by an information processing apparatus,
predicting a region in another prediction target captured image different from a predetermined prediction target captured image based on information output from the model by inputting information based on a plurality of the prediction target captured image obtained by capturing a prediction target and document information including findings for the predetermined prediction target captured image.

10. The information processing method according to claim 9, further comprising,
by the information processing apparatus,
predicting a region in the another prediction target captured image based on information output from the model by inputting, to the model, information based on a plurality of the prediction target captured image obtained by capturing the prediction target at different timings and the document information for the predetermined prediction target captured image.

11. The information processing method according to claim 10, further comprising,
by the information processing apparatus,
predicting a region in the another prediction target captured image based on information output from the model by inputting information based on a first prediction target captured image obtained by capturing the prediction target at a first timing and a second prediction target captured image obtained by capturing the prediction target at a timing different from the first timing, and the document information for the first prediction target captured image to the model.

12. The information processing method according to claim 11, further comprising,
by the information processing apparatus,
predicting a region in the another prediction target captured image based on information output from the model by inputting an integrated image obtained by integrating the first prediction target captured image and the second prediction target captured image and the document information to the model.

13. The information processing method according to claim 11, further comprising,
by the information processing apparatus,
predicting a region in the another prediction target captured image based on information output from the model by inputting each of a pair of the first prediction target captured image and the document information and a pair of the second prediction target captured image and the document information to the model.

14. The information processing method according to claim 9, wherein
the model is machine-learned using the first learning data including information indicating that the first captured image and the first document information match in time series, and the second learning data including information indicating that the second captured image and the first document information do not match in time series.

15. The information processing method according to claim 9, wherein
the model is machine-learned in a state in which the first document information is structured by at least position information of a region in the first captured image and information indicating a temporal change in a state of the region, the information processing method further comprising,
by the information processing apparatus,
predicting a region in the another prediction target captured image based on information output from the model by inputting the first document information to the model in a structured state of at least position information of a region in the first captured image and information indicating a temporal change in a state of the region.
